(19) United States
(12) Patent Application Publication
(10) Pub. No.: US 2003/0034321 A1
(43) Pub. Date: Feb. 20, 2003

(54) Sucking cap of baby's nursing bottle

(76) Inventor: Race Wu, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/931,032

(22) Filed: Aug. 17, 2001

(51) Int. Cl. A61J 11/02; A61J 9/04

(52) U.S. Cl. 215/11.5

(57) ABSTRACT

A sucking cap of a nursing bottle comprises a sucking portion which is provided with four ventilation holes and a fastening portion connected with the bottom end thereof. The fastening portion is provided with inner threads engageable with outer threads of the neck of the nursing bottle.

### FIELD OF THE INVENTION

The present invention relates generally to a sucking cap, and more particularly to an improvement on the sucking cap of a baby's nursing bottle.

### BACKGROUND OF THE INVENTION

As shown in FIG. 1, a sucking cap of the prior art comprises a sucking member 10 and a fastening member 20. The sucking member 10 is of a hollow shell body and is made of a soft silicone rubber. The sucking member 10 has a sucking end 11 and an annular portion 12 opposite to the sucking end 11 and extending outwards from the bottom periphery of the sucking member. Located between the annular portion 12 and the sucking end 11 is an annular groove 13. The fastening member 20 is of a short cylindrical construction and is made of a rigid plastic material. The fastening member 20 is provided in the top with a through hole 21 for disposing the sucking member 10. The fastening member 20 is provided with inner threads 22 engageable with outer threads 31 of the neck of a baby's nursing bottle 30.

As shown in FIG. 2, before the sucking cap is in use, the sucking member 10 is first put into the through hole 21 of the fastening member 20 such that the annular groove 13 is retained on the through hole 21. The fastening member 20 is then engaged with the outer threads 31 of the nursing bottle 30.

Such a prior art sucking cap as described above is defective in design in that the sucking member and the fastening member must be separated to facilitate the cleaning of the sucking cap. Without being separated, the juncture between the annular groove of the sucking member and the through hole of the fastening member can not be cleaned and dried, thereby resulting in deposit of milk dregs. In addition, prior to the reuse of the sucking cap, the sucking member and the fastening member must be once again joined together. In other words, it is tedious to use the prior art sucking cap. In terms of the production of the prior art sucking cap, the manufacturing and the packaging of the sucking member and the fastening member are done separately, thereby resulting in an increase in the production cost of the prior art sucking cap.

### SUMMARY OF THE INVENTION

It is the primary objective of the present invention to provide a baby's nursing bottle with a sucking cap which is easy to use and can be cleaned easily.

It is another objective of the present invention to provide a baby's nursing bottle with a sucking cap which is cost-effective.

In keeping with the principle of the present invention, the foregoing objectives of the present invention are attained by a sucking cap comprising a sucking portion which is provided at one end with a fastening portion having inner threads engageable with outer threads of the neck of a baby's nursing bottle.

### BRIEF DESCRIPTION OF THE DRAWINGS

FIG. 1 shows an exploded view of the prior art.

FIG. 2 shows a perspective view of the prior art in combination.

FIG. 3 shows a front view of the present invention.

FIG. 4 shows a sectional view taken along a line 4-4 as shown in FIG. 3.

FIG. 5 shows a sectional view taken along a line 5-5 as shown in FIG. 4.

FIG. 6 is same as FIG. 4 but shows a sectional view at the position of the imaginary line B of FIG. 5.

FIG. 7 shows a sectional view of the sucking portion of the present invention taken along a line 7-7 as shown in FIG. 5.

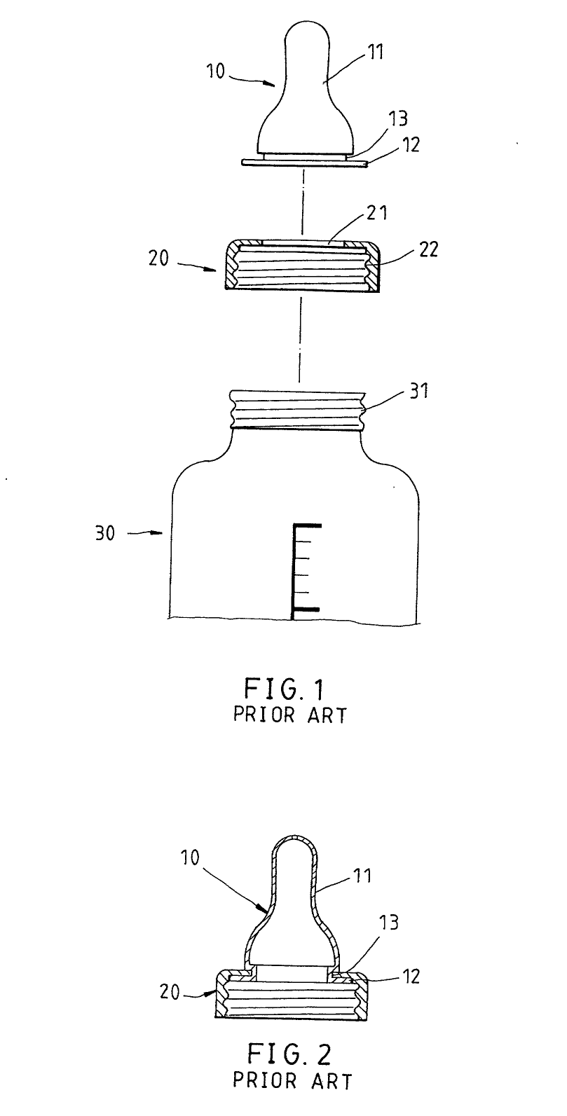

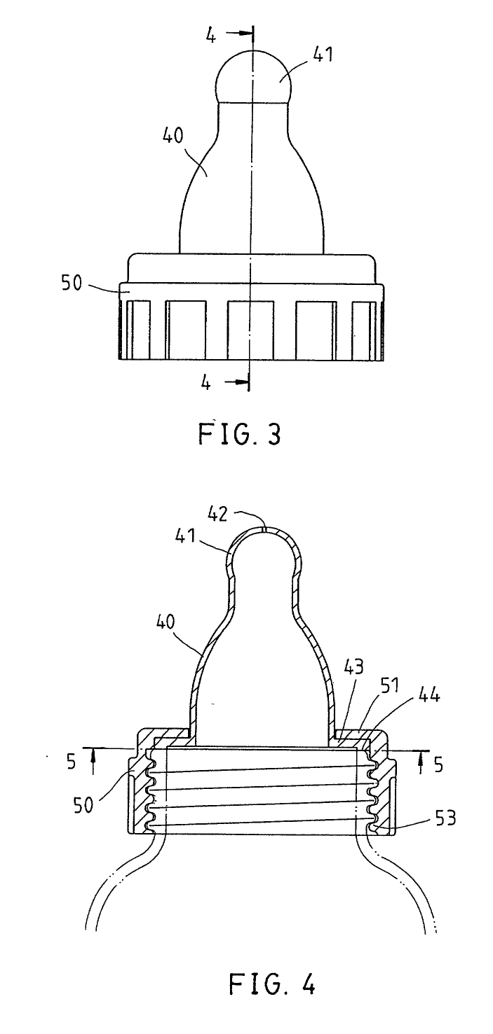

### DETAILED DESCRIPTION OF THE INVENTION

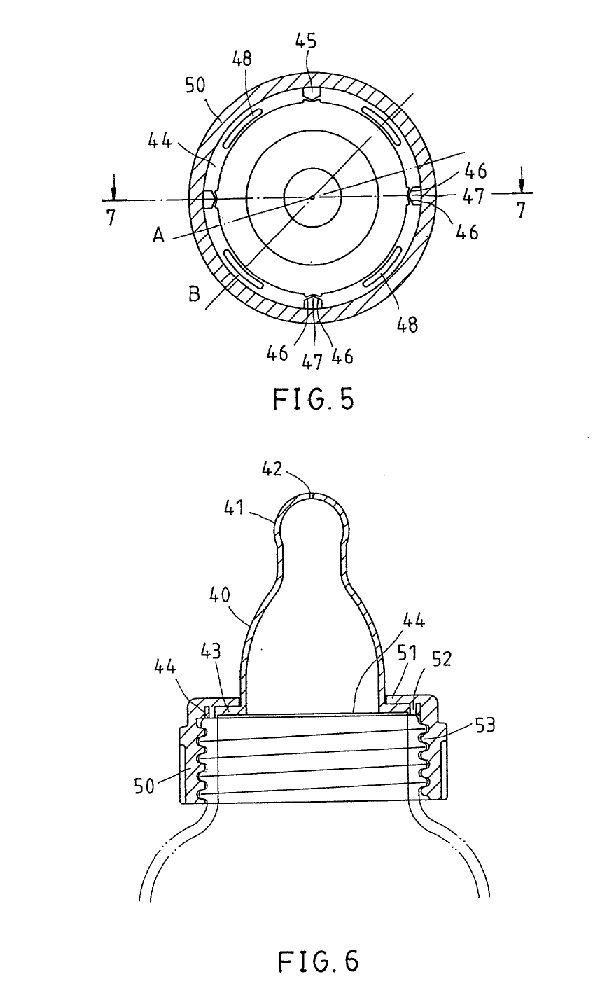

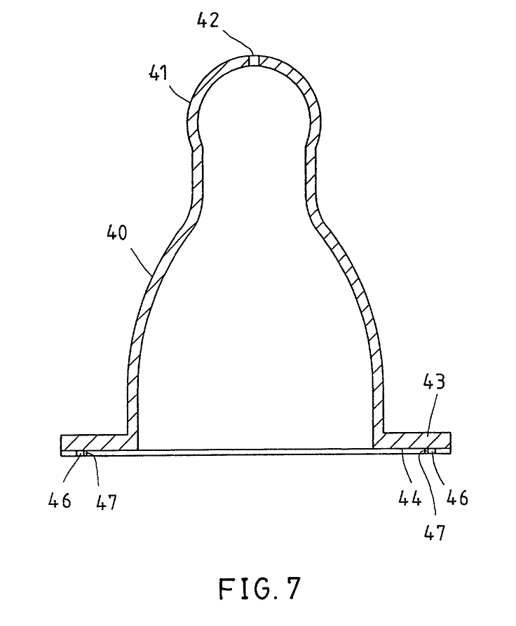

As shown in all drawings provided herewith, a sucking cap of the baby's nursing bottle comprises a sucking portion 40 which is made of a soft silicone rubber by injection molding and is a hollow shell body with a sucking end 41. The sucking end 41 is provided in the top with a through hole 42 through which milk or other liquid passes. The sucking portion 40 is provided along the edge of the bottom with an annular portion 43 extending outwards. A protruded ring 44 is extended under the annular portion 43. Four recesses 45 are arranged equidistantly along the protruded ring 44, as shown in FIG. 5. Each recess 45 is provided in the two side walls with a membrane 46 slanting toward the interior of the sucking portion. A one-way ventilation hole 47 is formed by two membranes. Located between the ventilation holes 47 is a long through hole 48. The annular portion 43 is provided in the upper end surface with a fastening portion 50 which is integrally formed therewith of a rigid plastic material and is a cylindrical shell body. The shoulder portion 51 of the top of the fastening portion is attached with the top of the annular portion 43. The underside of the shoulder 51 of the fastening portion is provided with four protruded pillars 52 extending downwards and plugging into the long through holes 48 of the sucking portion 40 such that the bottom ends of the protruded pillars 52 are flush with the underside of the protruded ring 44. The fastening portion 50 is provided with inner threads 53 engageable with outer threads of the neck of a baby's nursing bottle. In use, the inner threads of the fastening portion are engaged securely with the outer threads of the neck of the nursing bottle such that the underside of the protruded ring comes in close contact with the top of the neck, as shown in FIG. 6, and that the rigid protruded pillars of the protruded ring press against the top of the neck of the nursing bottle, thereby preventing the ventilation hole and the membrane from being pushed to deform to become disabled. In view of the fact that the fastening portion is not engaged with the neck of the nursing bottle in an airtight manner, and that the air pressure in the sucking portion tends to become smaller by the sucking action of a baby, the two membranes open up inwardly by the change in pressure in the interior of the nursing bottle. In the meantime, the atmospheric air enters the nursing bottle via the ventilation holes and the interstices between the threads, thereby resulting in formation of an air channel enabling the liquid contained in the nursing bottle to flow out easily.

The present invention has advantages over the prior art. In the first place, the sucking portion and the fastening portion of the present invention are made integrally to eliminate the packaging process and to prevent the poor contact between the sucking portion and the fastening portion as well as the leak. The present invention is a unit product, which is relatively cost-effective. The present invention is made integrally and can be therefore cleaned with ease and speed to prevent the deposition of dregs.

What is claimed is:

1. A sucking cap of a baby's nursing bottle, comprising a sucking portion which is provided with at least one ventilation hole and is provided at one end with a fastening portion made integrally therewith, said fastening portion having inner threads engageable with outer threads of the neck of the nursing bottle.

2. The sucking cap as defined in claim 1, wherein said sucking portion comprises an annular portion extending outward from the bottom thereof, said annular portion being provided in the underside with a protruded ring; wherein said ventilation hole is disposed in said protruded ring.

3. The sucking cap as defined in claim 2, wherein said protruded ring comprises at least one recess which is provided in two side walls with a membrane slanting toward the interior of said sucking portion, thereby enabling said recess to form a one-way ventilation hole.

4. The sucking cap as defined in claim 3, wherein said protruded ring further comprises at least two through holes; wherein said fastening portion comprises protruded pillars equal in number to said through holes and plugging into said through holes such that bottom ends of said protruded pillars are flush with the underside of said protruded ring.
